(19) United States
(12) Patent Application Publication
(10) Pub. No.: US 2021/0227055 A1
(43) Pub. Date: Jul. 22, 2021

(54) DATA TRANSMITTING METHOD, DATA RECEIVING METHOD, TRANSMITTING DEVICE, RECEIVING DEVICE, TRANSMISSION SYSTEM, AND COMPUTER STORAGE MEDIUM

(71) Applicant: SHENZHEN LENKENG TECHNOLOGY CO.,LTD, Shenzhen (CN)

(72) Inventor: Binghai GAO, Shenzhen (CN)

(73) Assignee: SHENZHEN LENKENG TECHNOLOGY CO.,LTD, Shenzhen (CN)

(21) Appl. No.: 17/075,722

(22) Filed: Oct. 21, 2020

Related U.S. Application Data
(63) Continuation of application No. PCT/CN2020/091853, filed on May 22, 2020.

(30) Foreign Application Priority Data
Jan. 19, 2020 (CN) 202010059507.X

(51) Int. Cl. H04L 29/06; H04Q 11/00; H04B 10/25

(52) U.S. Cl. CPC H04L 69/16; H04B 10/25; H04Q 11/0071

(57) ABSTRACT

Provided are a data transmitting method, a data receiving method, a transmitting device, a receiving device, a transmission system, and a computer storage medium. The transmitting method includes the following. multimedia data is obtained, the multimedia data is processed to obtain a first data with YUV420 format. the first data is encapsulated, through a user datagram protocol (UDP), to obtain a UDP data packet. the UDP data packet is transmitted to a first communication module via an input interface of the first communication module. By adopting the disclosure, the transmission cost can be reduced, a better solution is provided for the long-distance transmission of high-definition video data, and the user experience is high.

### CROSS REFERENCE TO RELATED APPLICATION

This application is a continuation of International Application No. PCT/CN2020/091853, filed on May 22, 2020, which is based upon and claims priority to Chinese Patent Application No. 202010059507.X, filed on Jan. 19, 2020, the entire contents of which are incorporated herein by reference.

### TECHNICAL FIELD

The disclosure relates to the technical field of network communication, and particularly to a data transmitting method, a data receiving method, a transmitting device, a receiving device, a transmission system, and a computer storage medium.

### BACKGROUND

At present, people's requirements for video quality are getting higher and higher, and people's requirements for transmission distance of video are also getting farther and farther. However, the amount of ultra-high-definition video data is large and high transmission bandwidth is required. An ultra-high-definition video is usually transmitted based on wire, however, there is a large loss of ultra-high-definition video data in long-distance transmission nowadays.

### SUMMARY

Based on the above problems and the shortcomings of the prior art, the disclosure provides a data transmitting method, a data receiving method, a transmitting device, a receiving device, a transmission system, and a computer storage medium to offer an excellent solution for long-distance transmission of high-definition video data. The user experience is high.

In a first aspect, a data transmitting method is provided. The data transmitting method includes the following.

A multimedia data is obtained.

The multimedia data is processed to obtain a first data with a YUV420 format.

The first data is encapsulated through a user datagram protocol (UDP) to obtain a UDP data packet.

The UDP data packet is transmitted to a first communication module via an input interface of the first communication module.

In a second aspect, a data receiving method is provided. The receiving method includes the following.

The UDP data packet is obtained from a second communication module through an output interface of the second communication module.

The UDP data packet is decapsulated through a UDP to obtain a first specific data with the YUV420 format.

The first specific data is recovered to obtain specific multimedia data.

In a third aspect, a transmitting device is provided. The transmitting device includes: an obtaining module, a processing module, an encapsulation module, and a first communication module. The obtaining module is configured to obtain multimedia data. The processing module is configured to process the multimedia data to obtain a first data with the YUV420 format. the encapsulation module is configured to encapsulate the first data through a UDP communication protocol to obtain a UDP data packet. The first communication module is configured to transmit the UDP data packet. The transmitting device is configured to execute the method of the first aspect.

In a fourth aspect, a receiving device is provided. The receiving device includes: a second communication module, a decapsulation module, and a recovery module. The second communication module is configured to obtain a UDP data packet from a transmitting device or a switch. The decapsulation module is configured to decapsulate the UDP data packet to obtain a first specific data with the YUV420 format. The recovery module is configured to recover the first specific data to obtain specific multimedia data. The receiving device is configured to execute the method of the second aspect.

In a fifth aspect, a transmission system is provided. The transmission system includes a transmitting device and a receiving device. The transmitting device is configured to execute the method of the first aspect. The receiving device is configured to execute the method of the second aspect.

In a sixth aspect, a transmitting device is provided. The transmitting device includes a first memory and a first processor coupled to the first memory. The first memory is configured to store a first application program instruction. The first processor is configured to invoke the first application program instruction to execute the follows. A multimedia data is obtained. The multimedia data is processed to obtain a first data with the YUV420 format. The first data is encapsulated through a user datagram protocol (UDP) to obtain a UDP data packet. The UDP data packet is transmitted to a first communication module via an input interface of the first communication module.

In a seventh aspect, a receiving device is provided. The receiving device includes a second memory and a second processor coupled to the second memory. The second memory is configured to store a second application program instruction. The second processor is configured to invoke the second application program instruction to execute the follows. A data receiving method is provided. The receiving method includes the following. The UDP data packet is obtained from a second communication module through an output interface of the second communication module. The UDP data packet is decapsulated through an UDP to obtain a first specific data with the YUV420 format. The first specific data is recovered to obtain specific multimedia data.

In an eighth aspect, a computer readable storage medium is provided. The computer readable storage medium stores a first computer program which is run by a first processor to execute the following. A multimedia data is obtained. The multimedia data is processed to obtain a first data with the YUV420 format. The first data is encapsulated through a user datagram protocol (UDP) to obtain a UDP data packet. The UDP data packet is transmitted to a first communication module via an input interface of the first communication module.

In a ninth aspect, a computer readable storage medium stores a second computer program. The second computer program is run by a second processor to execute the following. The UDP data packet is obtained from a second communication module through an output interface of the second communication module. The UDP protocol data packet is decapsulated through an UDP to obtain a first specific data with the YUV420 format. The first specific data is recovered to obtain specific multimedia data.

A data transmitting method, a data receiving method, a transmitting device, a transmission system, and a computer storage medium are provided. The transmitting device processes the multimedia data obtained to obtain a first data with a YUV420 format, encapsulates the first data through a UDP to obtain a UDP data packet, and transmits the UDP data packet to a receiving device via the first communication module. The receiving device obtains the UDP data packet through the second communication module, decapsulates the UDP data packet to obtain the first specific data with a YUV420 format, and recovers the first specific data to obtain the specific multimedia data. Compared with the prior art, the disclosure can realize long-distance transmission of high-definition video data by an optical module, and the user experience is high.

### BRIEF DESCRIPTION OF THE DRAWINGS

In order to explain the technical solutions in implementations of the disclosure more clearly, the drawings used in the description of the implementations are briefly introduced below. Obviously, the drawings in the following description are some implementations of the disclosure. For ordinary technicians, other drawings can be obtained based on these drawings without paying creative work.

FIG. 1 is a schematic flowchart of a data transmitting method according to the disclosure.

FIG. 2 is a schematic flowchart of a data receiving method according to the disclosure.

FIG. 3 is a schematic structural diagram of a transmitting device according to the disclosure.

FIG. 4 is a schematic structural diagram of another transmitting device according to the disclosure.

FIG. 5 is a schematic structural diagram of another transmitting device according to the disclosure.

FIG. 6 is a schematic structural diagram of another transmitting device according to the disclosure.

FIG. 7 is a schematic structural diagram of a receiving device according to the disclosure.

FIG. 8 is a schematic structural diagram of another receiving device according to the disclosure.

FIG. 9 is a schematic structural diagram of another receiving device according to the disclosure.

FIG. 10 is a schematic structural diagram of another receiving device according to the disclosure.

FIG. 11 is a schematic structural diagram of a transmission system according to the disclosure.

FIG. 12 is a schematic structural diagram of another transmission system according to the disclosure.

FIG. 13 is a schematic diagram of another transmission system according to the disclosure.

FIG. 14 is a schematic structural diagram of another transmitting device according to the disclosure.

FIG. 15 is a schematic structural diagram of another receiving device according to the disclosure.

### DETAILED DESCRIPTION

The technical solutions in the disclosure will be described clearly and completely in combination with the drawings in the disclosure. Obviously, the described implementations are part of the implementations of the disclosure, but are not all of the implementations.

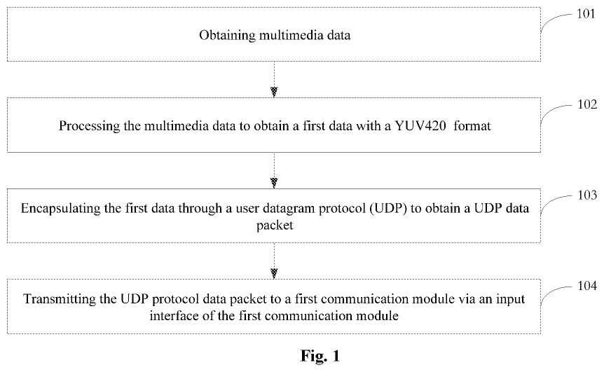

FIG. 1 is a schematic flowchart of a data transmitting method according to the disclosure. As shown in FIG. 1, the data transmitting method may include, but is not limited to, the following.

At block 101, multimedia data is obtained.

According to implementation of the disclosure, obtaining the multimedia data may include, but is not limited to, the following.

Method 1: the transmitting device obtains the multimedia data via a high definition multimedia interface (HDMI).

Specifically, the transmitting device can obtain multimedia data from the video source device (e.g. DVD, set-top box, camera) via three transition minimized differential signal (TMDS) data channels of the high definition multimedia interface (HDMI). Among them, the HDMI may also include a clock channel.

The multimedia data may include, but is not limited to, perception multimedia data such as text, data, sound, graphics, images, or videos (e.g. high-definition video of 1080P, 4K, 8K resolution, frame rate of 60 FPS, 100 FPS, or 120 FPS). The multimedia data may also include, but is not limited to, the following characteristic: high dynamic range imaging (HDR).

Method 2: the transmitting device obtains the multimedia data via a serial digital interface (SDI).

Method 3: the transmitting end can obtain multimedia data via the Type-C interface.

At block 102, The multimedia data is processed to obtain a first data with a YUV420 format.

According to implementation of the disclosure, processing the multimedia data to obtain the first data with the YUV420 format may include, but is not limited to, the following.

Scenario 1, if a format of the multimedia data is the RGB format, the multimedia data with the RGB format is converted, to the multimedia data with the YUV444 format through a color space converter (CSC), and the multimedia data with the YUV444 format is sampled to obtain a first data with the YUV420 format.

Scenario 2, if the format of the multimedia data is the YUV format, the multimedia data with the YUV format is sampled, by the transmitting device, to obtain a first data with the YUV420 format.

If the format of the multimedia data is the RGB format,

taking data among 8 pixels as an example, if the format of data among each pixel is the YUV444 format, the data among 8 pixels with the YUV444 format can be showed as follows.

YUV, YUV, YUV, YUV, YUV, YUV, YUV, YUV.

At present, the memory space occupied by the data among 8 pixels and with the YUV444 format can be: 8*8*3 bit=192 bits. The data among each pixel includes three components of Y, U, and V, where each component can occupy 8 bits. In other words, the data with the YUV444 format indicates that each component of Y corresponds to a set of UVs.

If a format of the data among each pixel is the YUV442 format, the data among each pixel and with the YUV442 format can be showed as follows.

At present, the memory space occupied, by the data among 8 pixels and with the YUV442 format, can be: 8*4*4 bit=128 bits. In other words, the data with the YUV422 format indicates that every two components of Y correspond to (share) a set of UVs.

If the format of the data among each pixel is the YUV420 format, the data among the 8 pixels and with the YUV420 format can be showed as follows.

Y, YUV, Y, Y, Y, YUV, Y, Y.

At present, the memory space occupied, by the data among 8 pixels and with the YUV420 format, can be: 8*2*6 bit=96 bits. It should be noted that the data with the YUV420 format indicates that every four components of Y can correspond to (share) a set of UV components.

It should be noted that, taking the data among 8 pixels as an example, the data with the YUV444 format is processed, by the transmitting device, to obtain the data with the YUV420 format. Compared with the data with the YUV444 format, the storage space occupied by the data among 8 pixels and with the YUV420 format occupies half of this storage space occupied previously (96/192).

At block 103, the first data is encapsulated through a user datagram protocol (UDP) to obtain a UDP data packet.

According to implementations of the disclosure, the first data is encapsulated through a UDP to obtain the UDP data packet as follows.

The transmitting device adds a UDP header and a UDP tail to the first data to obtain a UDP data packet including the first data, a UDP header and a UDP tail. Among them, the UDP header or the UDP tail can contain the control information such as the destination address, source address, port number, tag bit and so on.

At block 104, the UDP data packet is transmitted to the first communication module via an input interface of the first communication module.

According to implementations of the disclosure, transmitting the UDP data packet to the first communication module via the input interface of the first communication module may include, but is not limited to, the following.

Situation 1, the transmitting device can transmit the UDP data packet to the first optical module via the input interface of the first optical module (e.g. XF1, XAUX, RAUX), where the first optical module is configured to convert the UDP data packet into an optical signal.

The first optical module includes a single-mode single-fiber optical module with transmission rate not lower than a first threshold, and a multi-mode single-fiber optical module with transmission rate not lower than the first threshold. Optionally, the first threshold may be 10 Gbps, which is not limited here.

Situation 2, the transmitting device may transmit the UDP data packet to the first electrical module via the input interface of the first electrical module, where the first electrical module includes a communication module with transmission rate not lower than the first threshold.

When the first electrical module includes a physical interface transceiver (PHY) and a RJ-45 interface,

specifically, the transmitting device can transmit the UDP data packet to the PHY via an input interface of the PHY (e.g. XF1, XAUX, or RAUX). It should be noted that the transmitting device can output the UDP data packet, via the PHY, to the RJ-45 interface for outputting.

It should be noted that transmitting the UDP data packet to the first communication module via the input interface of the first communication module may further include the following.

The transmitting device may transmit the UDP data packet to the first optical module via the input interface of the first optical module, and may also transmit the UDP data packet to the first electrical module via the input interface of the PHY in the first electrical module simultaneously.

It should be noted that the first communication module may be used for communication connection with a switch, where the switch may include a Gigabit switch or a 10 Gigabit switch, and the switch may also be a stack switch.

Specifically, when the first communication module is the first optical module,

the transmitting device may transmit the UDP data packet to the first optical module via the input interface of the first optical module, convert the UDP data packet into an optical signal by the first optical module, and transmit the optical signal to the switch via the optical interface of the first optical module.

Specifically, when the first communication module is the first electrical module,

the transmitting device may transmit the UDP data packet to the first electrical module via the input interface of the first electrical module, and transmit, via the PHY, the RJ-45 interface and a network cable, the UDP data packet to the switch.

It should be noted that the first communication module may be used for communication connection with the receiving device.

Specifically, when the first communication module is the first optical module,

the transmitting device may transmit the UDP data packet to the first optical module via the input interface of the first optical module, convert the UDP data packet into an optical signal by the first optical module, and transmit the optical signal to the receiving device via the optical interface of the first optical module.

Specifically, when the first communication module is the first electrical module,

the transmitting device may transmit the UDP data packet to the first electrical module via the input interface of the first electrical module, and transmit the UDP data packet to the receiving device via the electrical interface such as the RJ-45 interface in the first electrical module and the network cable.

According to implementations of the disclosure, a data transmission method is provided. The transmitting device obtains the multimedia data. The transmitting device processes the multimedia data to obtain the first data with the YUV420 format. The transmitting device encapsulates the first data through the UDP to obtain the UDP data packet. The transmitting device transmits the UDP data packet to the first communication module via the input interface of the first communication module. In a word, the disclosure can reduce transmission costs and provide a better solution for long-distance transmission of high-definition video data.

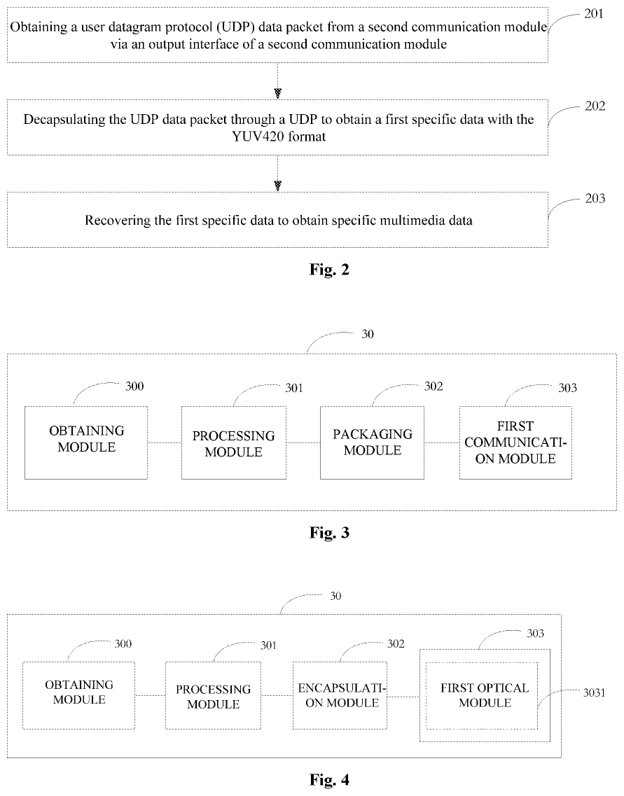

FIG. 2 is a schematic flowchart of a data receiving method according to the disclosure. As shown in FIG. 2, the data receiving method may include, but is not limited to, the following.

At block 201, a user datagram protocol (UDP) data packet is obtained from a second communication module via an output interface of the second communication module.

Obtaining the UDP data packet from the second communication module via the output interface of the second communication module may specifically include, but is not limited to, the following.

Method 1: the receiving device can obtain the UDP data packet from a second optical module via an output interface of the second optical module, where the second optical module includes a single-mode single-fiber optical module with transmission rate not lower than a second threshold, and a multi-mode single-fiber optical module with transmission rate not lower than the second threshold. Optionally, the second threshold may be 10 Gbps, which is not limited here.

Method 2: the receiving device can obtain the UDP data packet from a second electrical module via an output interface of the second electrical module. The second electrical module includes a communication module with transmission rate not lower than the second threshold.

When the second electrical module includes physical interface transceiver (PHY) and RJ-45 interface,

in method 2, the receiving device may obtain the UDP data packet from the second electrical module via the output interface of the PHY of the second electrical module. It should be noted that the receiving device may obtain the UDP data packet from the transmitting device or the switch via the RJ-45 interface of the second electrical module.

According to the implementation of the disclosure, before obtaining the UDP data packet from the second communication module via the output interface of the second communication module, the data receiving method may further include the following.

Processing method 1: the receiving device obtains the UDP data packet from the transmitting device by the second communication module.

In processing method 1: when the second communication module is the second optical module,

the receiving device can obtain the optical signal from the transmitting device via the input interface of the second optical module (e.g. XF1, XAUX, RAUX), and convert the optical signal into the UDP data packet by the second optical module.

When the second communication module is the second electrical module, the receiving device can obtain the UDP data packet from the transmitting device via the input interface of the PHY in the second electrical module (e.g. XF1, XAUX, RAUX).

Processing method 2: the receiving device obtains the UDP data packet from the switch by the second communication module, where the switch may include a Gigabit switch or a 10 Gigabit switch, and the switch may also be a stack switch.

In processing method 2, when the second communication module is the second optical module,

the receiving device can obtain optical signals from the switch via the input interfaces of the second optical module (e.g. XF1, XAUX, RAUX), and convert the optical signals into the UDP data packet by the second optical module.

When the second communication module is the second electrical module, the receiving device can obtain the UDP data packet from the switch via the input interface of the PHY in the second electrical module (e.g. XF1, XAUX, RAUX).

It should be noted that before obtaining the UDP data packet from the second communication module via the output interface of the second communication module, the data receiving method may further include the following.

The receiving device can obtain the UDP data packet from the switch via the input interface of the second optical module, and obtain the UDP data packet from the switch via the input interface of the PHY in the second electrical module.

or,

The receiving device can obtain the UDP data packet from the transmitting device via the input interface of the second optical module, and obtain the UDP data packet from the transmitting device via the input interface of the PHY in the second electrical module.

At block 202, the UDP data packet is decapsulated through the UDP to obtain a first specific data with the YUV420 format.

According to the implementation of the disclosure, the UDP data packet is decapsulated through the UDP to obtain the first specific data with the YUV420 format, which may specifically include, but is not limited to, the following.

The receiving device removes a UDP header and a UDP tail of the UDP data packet through a UDP to obtain the first specific data with the YUV420 format from the UDP data packet.

At block 203, the first specific data is recovered to obtain specific multimedia data.

According to implementations of the disclosure, recovering the first specific data to obtain the specific multimedia data may include, but is not limited to, the following.

Scenario 1, if a format of the specific multimedia data is a RGB format, the receiving device interpolates the first specific data to obtain the data with the YUV444 format, and converts, through a color space converter (CSC), the first specific data with the YUV444 format into the specific multimedia data with the RGB format.

Scenario 2, if the format of the specific multimedia data is a YUV format, the receiving device interpolates the first specific data to obtain the specific multimedia data with the YUV444 format, or the specific multimedia data with the YUV422 format.

It should be noted that after recovering the first specific data and obtaining the specific multimedia data, the data receiving method may further include the following.

The receiving device can output specific multimedia data to a display device via an output interface such as a HDMI, a SDI, or a Type-C interface, where the display device can be configured to display or play the specific multimedia data.

It should be noted that for the definitions and descriptions not explained in the implementation of the disclosure, reference may be made to the implementation in FIG. 1, and the implementation of the disclosure are not described in detail.

A transmitting device is provided according to the disclosure. The transmitting device can be configured to execute the method described in the implementation of FIG. 1. The transmitting device shown in FIG. 3 can be configured to execute the content described in the implementation of FIG. 1.

As shown in FIG. 3, the transmitting device 30 may include, but is not limited to, an obtaining module 300, a processing module 301, a packaging module 302, and a first communication module 303.

The obtaining module 300 can be configured to obtain multimedia data.

The processing module 301 can be configured to process multimedia data to obtain the first data with a YUV420 format.

The encapsulation module 302 can be configured to encapsulate the first data through a user datagram protocol (UDP) to obtain a UDP data packet.

The obtaining module 300 can be specifically configured to obtain multimedia data via the HDMI, or obtain multimedia data via the SDI.

The processing module 301 can be specifically configured to execute the following.

If a format of the multimedia data is the RGB format, the multimedia data with the RGB format is converted into the multimedia data with the YUV444 format through a color space converter (CSC), and the multimedia data with the YUV444 format is sampled to obtain the first data with the YUV420 format.

or,

if the format of the multimedia data is the YUV format, the multimedia data with the YUV format is sampled to obtain the first data with the YUV420 format.

The first communication module 303 may be configured to transmit the UDP data packet to the switch or the receiving device.

Specifically, the first communication module 303 may include a first optical module;

The disclosure provides a schematic structural diagram of another transmitting device. As shown in FIG. 4, the first communication module 303 includes a first optical module 3031.

The transmitting device 30 may transmit the UDP data packet to the first optical module 3031 based on the interface of the first optical module 3031, convert the UDP data packet into an optical signal through the first optical module 3031, and then transmit the optical signal to the switch or the receiving device via the optical interface of the first optical module 3031.

Specifically, the first communication module 303 may include a first electrical module.

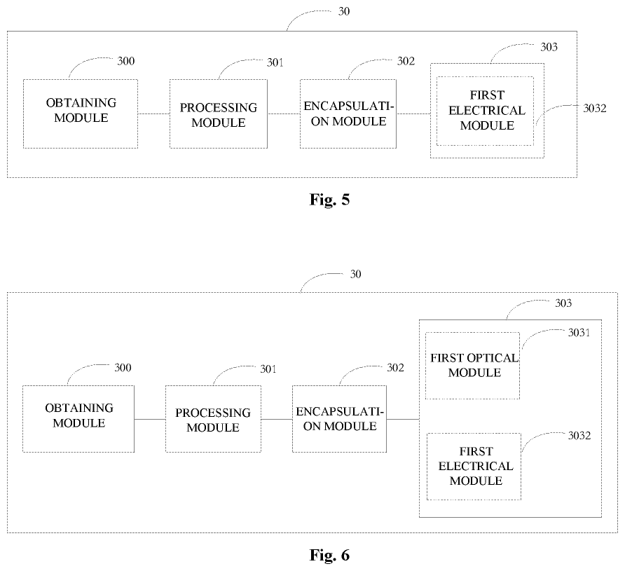

According to the disclosure, a schematic structural diagram of another transmitting device is provided. As shown in FIG. 5, the first communication module 303 includes a first electrical module 3032.

The transmitting device 30 can transmit the UDP data packet to the first electric module 3032 based on the interface of the first electric module 3032, and transmit the UDP data packet to the switch or the receiving device via the electric interface such as the RJ-45 interface of the PHY in the first electric module 3032 and a network cable.

It should be noted that the first communication module 303 may further include a first optical module and a first electrical module.

According to the disclosure, a schematic structural diagram of another transmitting device is provided. As shown in FIG. 6, the first communication module 303 may include a first optical module 3031 and a first electrical module 3032.

The transmitting device 30 may transmit the UDP data packet to the first optical module 3031 based on the interface of the first optical module 3031, convert the UDP data packet into an optical signal by the first optical module 3031, and transmit the optical signal via the optical interface of the first optical module 3031 to the switch or the receiving device. At the same time, the UDP data packet can be transmitted to the first electrical module 3032, and the UDP data packet is transmitted to the switch or the receiving device via the electrical interface such as the RJ-45 interface of the PHY in the first electrical module 3032 and the network cable.

It should be understood that the transmitting device 30 is only taken as an example according to implementations of the disclosure, and the transmitting device 30 may have more or less components than shown, may combine two or more components, or may adopt different arrangements of components.

It can be understood that a specific implementation manner of the functional module is included in the transmitting device 30, reference may be made to the implementation shown in FIG. 2, and details are not described herein again.

FIGS. 3-6 are only configured to explain implementations of the disclosure, and should not be limited to the disclosure.

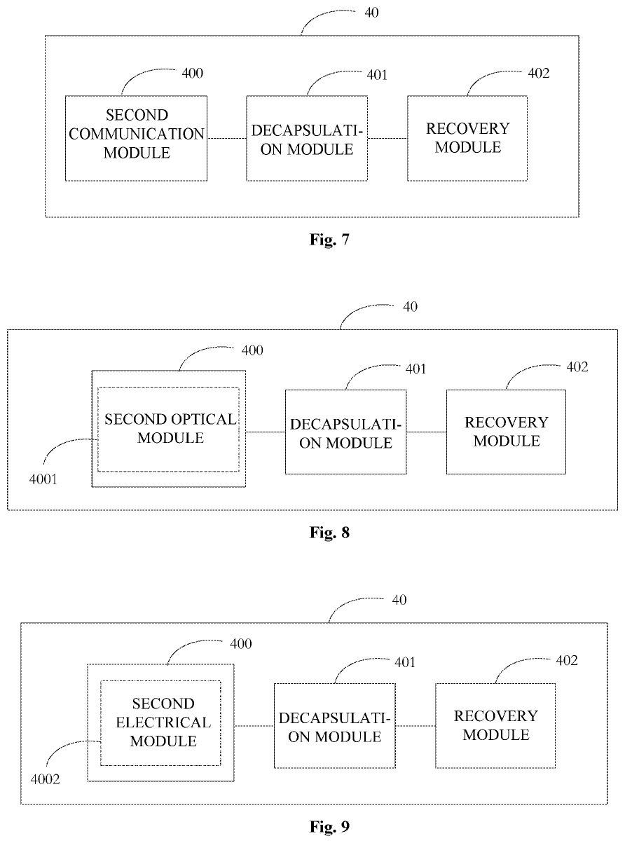

The disclosure provides a receiving device. The receiving device can be configured to execute the receiving method described in implementations of FIG. 2. Among them, the receiving device shown in FIG. 7 can be configured to execute the content described in implementations of FIG. 2.

As shown in FIG. 7, the receiving device 40 may include, but is not limited to, a second communication module 400, a decapsulation module 401, and a recovery module 402.

The second communication module 400 may be configured to obtain a user datagram protocol (UDP) data packet from the transmitting device or the switch.

The decapsulation module 401 can be configured to decapsulate the UDP data packet through a UDP to obtain the first specific data with the YUV420 format.

The recovery module 402 can be configured to recover the first specific data to obtain specific multimedia data.

The recovery module 402 can be specifically configured to execute the following.

If a format of the specific multimedia data is a RGB format, the first specific data is interpolated to obtain the data with the YUV444 format, and the data with the YUV444 format is converted into the specific multimedia data with the RGB format through a color space converter (CSC).

or,

if a format of the specific multimedia data is a YUV format, the first specific data is interpolated to obtain the specific multimedia data with the YUV444 format or the specific multimedia data with the YUV422 format.

Specifically, the second communication module 400 may include a second optical module, where the second optical module may include an optical module with transmission rate not lower than a second threshold, and the second threshold may be 10 Gbps.

The disclosure provides a schematic structural diagram of another receiving device. As shown in FIG. 8, the second communication module 400 includes a second optical module 4001.

The receiving device 40 may convert the optical signal obtained from the transmitting device or the switch into a UDP data packet via the input interface (e.g. XF1, XAUX, RAUX) of the second optical module 4001.

Specifically, the second communication module 400 may include a second electrical module, where the second electrical module may include a communication module with transmission rate not lower than a second threshold, and the second threshold may be 10 Gbps. The communication module with transmission rate not lower than the second threshold may include a second physical transceiver and a second RJ-45 interface.

According to implementations of the disclosure, a schematic structural diagram of another receiving device is provided. As shown in FIG. 9, the second communication module 400 includes a second electrical module 4002.

The receiving device 40 may obtain the UDP data packet from the transmitting device or the switch via the input interface (e.g. XF1, XAUX, RAUX) of the second electrical module 4002.

It should be noted that the second communication module 400 may further include a first optical module and a first electrical module.

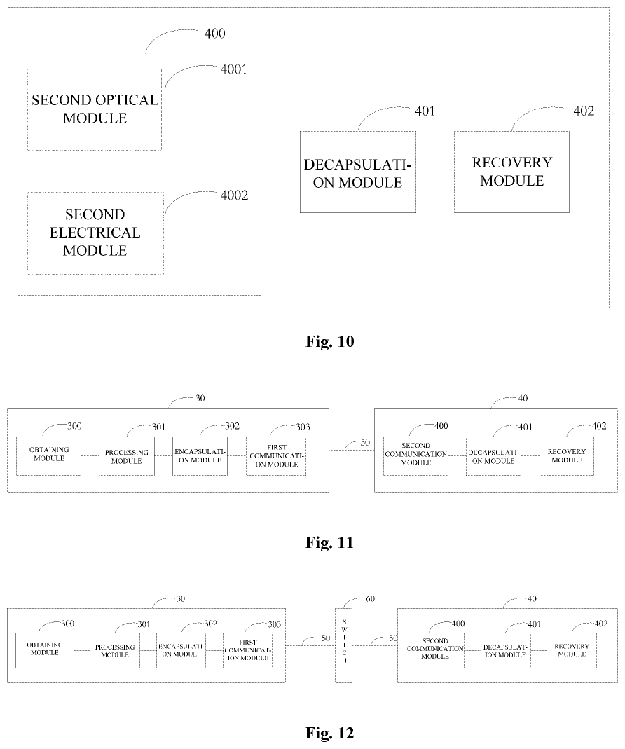

According to implementations of the disclosure, a schematic structural diagram of another receiving device. As shown in FIG. 10, the second communication module 400 may include a first optical module 4001 and a first electrical module 4002.

The receiving device 40 can convert the optical signal obtained from the transmitting device or the switch into the UDP data packet via the input interface of the second optical module 4001, and simultaneously obtain the UDP data packet from the transmitting device or the switch via the input interface of the second electrical module 4002.

It should be understood that the receiving device 40 is only taken as an example in the implementations of the disclosure, and the receiving device 40 may have more or less components than shown, may combine two or more components, or may adopt different arrangements of components.

It can be understood that a specific implementation manner of the functional module is included in the receiving device 40, reference may be made to the embodiment shown in FIG. 2, and details are not described herein again.

FIGS. 7-10 are only used to explain implementations of the disclosure, and should not be limited to the disclosure.

According to implementation of the disclosure, a schematic diagram of a data transmission system is provided. As shown in FIG. 11, the transmission system may include, but is not limited to: a transmitting device 30, a receiving device 40, and a wire 50, where the transmitting device 30 may be configured to perform the transmitting method described in the implementations of FIG. 1, and the receiving device 40 may be configured to execute the receiving method described of the implementations in FIG. 2.

The transmitting device 30 may include, but is not limited to, an obtaining module 300, a processing module 301, a packaging module 302, and a first communication module 303.

The obtaining module 300 can be configured to obtain multimedia data.

The processing module 301 can be configured to process the multimedia data to obtain the first data with YUV420 format.

The encapsulation module 302 can be configured to encapsulate the first data through a user datagram protocol (UDP) to obtain a UDP data packet.

The receiving device 40 may include, but is not limited to, a second communication module 400, a decapsulation module 401, and a recovery module 402.

The second communication module 400 may be configured to obtain a UDP data packet from the transmitting device or the switch.

The decapsulation module 401 can be configured to decapsulate the UDP data packet through a UDP to obtain the first specific data with the YUV420 format.

The recovery module 402 can be configured to recover the first specific data to obtain specific multimedia data.

It should be noted that the transmitting device 30 and the receiving device 40 are connected with each other via the wire 50, where the transmitting device 30 and the receiving device 40 may be included as follows.

Scenario 1, when the first communication module 303 is the first optical module, the wire 50 is an optical fiber, and the second communication module 400 is the second optical module, the transmitting device 30 communicate, by the first optical module and the optical fiber, with the receiving device 40 by the second optical module.

Scenario 2, when the first communication module 303 is the first electrical module, the wire 50 is a network cable, and the second communication module 400 is a second electrical module, the transmitting device 30 communicate, via a RJ-45 interface in the first electrical module and the cable, with the receiving device 40 via a RJ-45 interface in the second electrical module.

Understandably, the specific implementation of the functional modules is included in the transmission system of FIG. 11, reference may be made to the implementations shown in FIGS. 1-10, and details are not described herein again.

According to implementations of the disclosure, a schematic diagram of another data transmission system is provided. As shown in FIG. 12, the transmission system may include, but is not limited to, a transmitting device 30, a receiving device 40, a wire 50, and a switch 60, where the transmitting device 30 may be configured to perform the transmitting method described in the embodiment of FIG. 1, the receiving device 40 may be configured to perform the receiving method described in the implementation of FIG. 2.

In implementations of the disclosure, the transmitting device 30 may transmit the UDP data packet to the switch based on the wire 50 by the first communication module 300. Specifically,

when the first communication module 300 is a first optical module and the wire 50 is an optical fiber,

the transmitting device 30 may transmit the UDP data packet to the first optical module based on an input interface of the first optical module, convert the UDP data packet into an optical signal by the first optical module, and transmit the optical signal to the switch via an optical interface of the first optical module and the optical fiber.

When the first communication module 300 is a first electrical module and the wire 50 is a network cable,

the transmitting device 30 may transmit the UDP data packet to the first electric module based on the input interface of the first electric module, and transmit the UDP data packet to the switch via the electric interface such as the RJ-45 interface in the first electric module and the wire 50.

It should be noted that when the second communication module 400 is a second optical module and the wire 50 is an optical fiber,

the receiving device 40 can convert an optical signal obtained from the switch into a UDP data packet via the input interface (e.g. XF1, XAUX, RAUX) of the second optical module.

When the second communication module 400 is the second electrical module and the wire 50 is the network cable,

the receiving device 40 can obtain the UDP data packet from the switch via the input interface (e.g. XF1, XAUX, RAUX) of the second electrical module.

Understandably, the specific implementation of the functional modules is included in the transmission system of FIG. 12, reference may be made to the implementations shown in FIGS. 1-10, and details are not described herein again.

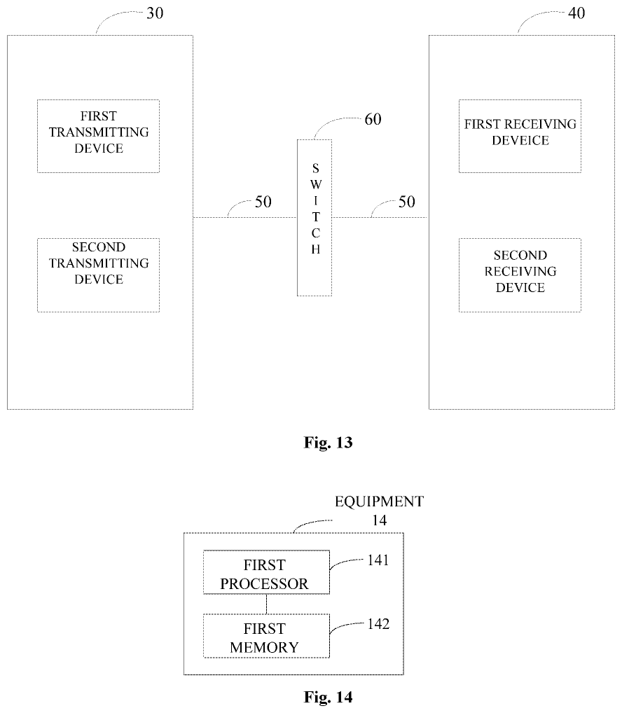

According to implementations of the disclosure, a schematic diagram of another data transmission system is provided. As shown in FIG. 13, the transmission system may include, but is not limited to, a transmitting device 30, a receiving device 40, a wire 50, and a switch 60, where the transmitting device 30 may be configured to perform the transmitting method described in implementations of FIG. 1, the receiving device 40 may be configured to perform the receiving method described in implementations of FIG. 2.

According to implementations of the disclosure, the transmitting device 30 may include, but is not limited to, a first transmitting device and a second transmitting device.

The receiving device 40 may include, but is not limited to, a first receiving device and a second receiving device.

It should be noted that multiple transmitting devices included in the transmitting device 30 may be distributed in one or more different multicast domains, and multiple receiving devices included in the receiving device 40 may be distributed in the one or more different multicast domains.

According to implementations of the disclosure, a number of different situations are exemplified below to explain the data transmission system.

Situation 1, the transmission system may include a multicast domain 1, where the multicast domain 1 may include, but is not limited to, a first transmitting device and a first receiving device.

In the situation 1, the first transmitting device may transmit a UDP data packet to the switch 60 and the wire 50 by the communication module of the first transmitting device, and accordingly, the second receiving device may obtain the UDP data packet from the switch 60 the wire 50 by the communication module of the second receiving device.

Specifically, when the communication module of the first transmitting device is an optical module, the wire 50 is an optical fiber, and the communication module of the first receiving device is an optical module,

the first transmitting device may transmit the UDP data packet to the optical module based on the input interface of the optical module in the first transmitting device, convert the UDP data packet into an optical signal by the optical module in the first transmitting device, and then transmit the optical signal to the switch based on the optical fiber via the optical interface of the optical module in the first transmitting device.

The first receiving device may convert the optical signal obtained from the switch 60 into a UDP data packet via the input interface (e.g. XF1, XAUX, RAUX) of the optical module in the first receiving device.

When the communication module of the first transmitting device is an electrical module, the wire 50 is a network cable, and the communication module of the first receiving device is an electrical module,

The first transmitting device may transmit the UDP data packet to the electric module in the first transmitting device based on the input interface of the electric module in the first transmitting device, and transmit the UDP data packet to the switch 60 via the electrical interface such as the RJ-45 interface in the electric module of the first transmitting device and the network cable.

The first receiving device may obtain the UDP data packet from the switch 60 through the input interface (e.g. XF1, XAUX, RAUX) of the electrical module of the first receiving device.

Situation 2, the transmission system may include a multicast domain 1, where the multicast domain 1 may include, but is not limited to, a first transmitting device, a second transmitting device, and a first receiving device.

In the situation 2, the first transmitting device can transmit, by the communication module of the first transmitting device, the UDP data packet to the switch 60 based on the wire 50, the second transmitting device can transmit, by the communication module of the second transmitting device, the UDP data packet to the switch 60 based on the wire 50. Accordingly, the first receiving device may receive from the switch 60, by the communication module of the first receiving device, a UDP data packet transmitted by the first transmitting device and a UDP data packet transmitted by the second transmitting device, based on the wire 50.

It should be noted that an application process of the device described in the situation 2, refer to an application processing procedure of the device described in the situation 1, which will not be repeated here.

Situation 3, the transmission system may include a multicast domain 1, where the multicast domain 1 may include, but is not limited to, a first transmitting device, a first receiving device, and a second receiving device.

In the situation 3, the first transmitting device can transmit, by the communication module of the first transmitting device, the UDP data packet to the switch 60 based on the wire 50. Accordingly, the first receiving device can receive from the switch 60, by the communication module of the first receiving device, a UDP data packet transmitted by the first transmitting device and a UDP data packet transmitted by the first transmitting device, based on the wire 50. It should be noted that an application process of the device described in the situation 3 may refer to an application processing procedure of the device described in the situation 1, which will not be repeated here.

Situation 4, the transmission system may include a multicast domain 1, where the multicast domain 1 may include, but is not limited to, a first transmitting device, a second transmitting device, a first receiving device, and a second receiving device.

In the situation 4, the first transmitting device can transmit, by the communication module of the first transmitting device, the UDP data packet to the switch 60 based on the wire 50, the second transmitting device can transmit, by the communication module of the second transmitting device, the UDP data packet to the switch 60 based on the wire 50.

Correspondingly, the first receiving device may obtain from the switch 60, by the communication module of the first receiving device, from the switch 60, the UDP data packet transmitted by the first transmitting device and the UDP data packet transmitted by the second transmitting device, based on the wire 50. The second receiving device can obtain from the switch 60, by the communication module of the second receiving device, the UDP data packet transmitted by the first transmitting device and the UDP data packet transmitted by the second transmitting device, based on the wire 50.

It should be noted that the application process of the device described in the situation 4, refer to the specific application processing procedure of the device described in the situation 1, which will not be repeated here.

Situation 5: the transmission system may include a multicast domain 1, and a multicast domain 2, where the multicast domain 1 may include, but is not limited to, a first transmitting device and a first receiving device, and the multicast domain 2 may include, but is not limited to, a second transmitting device and a second receiving device.

In the multicast domain 1, the first transmitting device can transmit, through the communication module of the first transmitting device, the UDP data packet to the switch 60 based on the wire 50. Accordingly, the first receiving device can obtain from the switch 60, by the communication module of the first receiving device, the UDP data packet transmitted by the first transmitting device based on the wire 50.

In the multicast domain 2, the second transmitting device can transmit, by the communication module of the second transmitting device, the UDP data packet to the switch 60 based on the wire 50. Accordingly, the second receiving device can obtain from the switch 60, by the communication module the second receiving device, the UDP data packet transmitted by the second transmitting device based on the wire 50.

It should be noted that the application processing procedures of the devices do not affect each other in different multicast domains. For an application process of the device described in the situation 5, refer to the specific application processing procedure of the device described in the situation 1, which will not be repeated here.

Situation 6: the transmission system may include a multicast domain 1 and a multicast domain 2.

Among them, the multicast domain 1 may include, but is not limited to, the first transmitting device, the second transmitting device and the first receiving device. The multicast domain 2 may include, but is not limited to, the third transmitting device, the second receiving device and the third receiving device.

In the multicast domain 1, the first transmitting device can transmit the UDP data packet to the switch 60 based on the wire 50 by the communication module of the first transmitting device, the second transmitting device can transmit, by the communication module of the second transmitting device, the UDP data packet to the switch 60 based on the wire 50. Accordingly, the first receiving device may obtain from the switch 60, by the communication module of the first receiving device, the UDP data packet transmitted by the first transmitting device and the UDP data packet transmitted by the second transmitting device based on the wire 50.

In the multicast domain 2, the third transmitting device can transmit, by the communication module of the third transmitting device, the UDP packet to the switch 60 based on the wire 50. Accordingly, the second receiving device can obtain from the switch 60, by the communication module of the second receiving device, the UDP data packet transmitted by the third transmitting device based on the wire 50. The third receiving device can obtain from the switch 60, by the communication module of the third receiving device, the UDP data packet transmitted from the third transmitting device based on the wire 50.

It should be noted that an application process of the device described in the situation 6, refer to the specific application processing procedure of the device described in the situation 1, which will not be repeated here.

Situation 7, the transmission system may include a multicast domain 1 and a multicast domain 2.

Among them, the multicast domain 1 may include, but is not limited to, a first transmitting device, a first receiving device and a second receiving device, the multicast domain 2 may include, but is not limited to, a second transmitting device, a third receiving device and the four receiving devices.

In the multicast domain 1, the first transmitting device can transmit, by the communication module of the first transmitting device, the UDP data packet to the switch 60 based on the wire 50. Accordingly, the first receiving device can obtain from the switch 60, by the communication module of the first receiving device, the UDP data packet transmitted by the first transmitting device based on the wire 50. The second receiving device may obtain from the switch 60, by the communication module of the second receiving device, the UDP data packet transmitted by the first transmitting device based on the wire 50.

In the multicast domain 2, the second transmitting device can transmit, by the communication module of the second transmitting device, the UDP data packet to the switch 60 based on the wire 50. Accordingly, the third receiving device can obtain from the switch 60, by the communication module of the third receiving device, the UDP data packet transmitted by the second transmitting device based on the wire 50. The fourth receiving device may obtain, by the communication module of the fourth receiving device, the UDP data packet transmitted by the second transmitting device from the switch 60 based on the wire 50.

It should be noted that an application process of the device described in the situation 7, refer to the specific application processing procedure of the device described in the situation 1, which will not be repeated here.

Situation 8, the transmission system may include a multicast domain 1 and a multicast domain 2.

Among them, the multicast domain 1 may include, but is not limited to, the first transmitting device, the second transmitting device and the first receiving device, where the multicast domain 2 may include, but is not limited to, the third transmitting device, the fourth transmitting device, and the second receiving device.

In the multicast domain 1, the first transmitting device can transmit, by the communication module of the first transmitting device, the UDP data packet to the switch 60 based on the wire 50. The second transmitting device can transmit, by the communication module of the second transmitting device, the UDP data packet to the switch 60 based on the wire 50. Accordingly, the first receiving device may obtain from the switch 60, by the communication module of the first receiving device, the UDP data packet transmitted by the first transmitting device and the UDP data packet transmitted by the second transmitting device based on the wire 50.

In the multicast domain 2, the third transmitting device can transmit, by the communication module of the third transmitting device, the UDP data packet to the switch 60 based on the wire 50. The fourth transmitting device can transmit, by the communication module of the fourth transmitting device, the UDP data packet to the switch 60 based on the wire 50. Accordingly, the second receiving device may obtain from the switch 60, by the communication module of the second receiving device, the UDP data packet transmitted by the third transmitting device and the UDP data packet transmitted by the fourth transmitting device based on the wire 50.

It should be noted that an application process of the device described in the situation 8, refer to the specific application processing procedure of the device described in the situation 1, which will not be repeated here.

According to implementations of the disclosure, a transmitting device is provided. The transmitting device can be configured to perform the method described in the embodiment of FIG. 1. The transmitting device shown in FIG. 14 can be configured to execute the content described in the implementations of FIG. 1.

As shown in FIG. 14, the transmitting device 14 may include, but is not limited to, a first memory 142 and a first processor 141 coupled to the first memory 142.

The first memory 142 may be specifically configured to store first application program instructions.

The first processor 141 may be specifically configured to call the first application program instructions stored in the first memory 142 to perform the following.

Multimedia data is obtained. The multimedia data is processed to obtain the first data with a YUV420 format. The first data is encapsulated through a user datagram protocol (UDP) to obtain a UDP data packet.

It should be noted that the transmitting device 14 is further configured to transmit the UDP data packet to the first communication module via an input interface of the first communication module.

The first processor 141 can be specifically configured to obtain multimedia data via a HDMI (high definition multimedia interface), a Type-C interface or a SDI (serial digital interface).

The first processor 141 can be further specifically configured to execute the following.

If a format of the multimedia data is the RGB format, the multimedia data with the RGB format is converted into the multimedia data with the YUV444 format through a color space converter (CSC), and the multimedia data with the YUV444 format is sampled to obtain the first data with the YUV420 format.

or,

if the format of the multimedia data is the YUV format, the multimedia data with the YUV format is sampled to obtain the first data with the YUV420 format.

It should be understood that the transmitting device 14 is only taken as an example according to at least one implementation of the disclosure. The transmitting device 14 may have more or fewer components than shown, may combine two or more components, or may adopt different arrangements of components.

Understandably, the specific implementation manner of the functional components included in the transmitting device 14 of FIG. 14, reference may be made to the implementation of FIG. 1, and details are not described herein again.

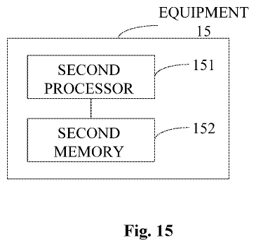

A receiving device is provided according to implementations of the disclosure, which can be configured to perform the method described in the implementation of FIG. 7. The transmitting device shown in FIG. 15 can be configured to execute the content described in the implementation of FIG. 7.

As shown in FIG. 15, the receiving device 15 may include, but is not limited to, a second memory 152 and a second processor 151 coupled to the second memory 152.

The second memory 152 may be specifically configured to store second application program instructions.

The second processor 151 may be specifically configured to call the second application program instructions stored in the second memory 152 to perform the following.

The second processor 151 can be specifically configured to execute the following.

If a format of the specific multimedia data is a RGB format, the first specific data is interpolated to obtain the data with the YUV444 format, and the data with the YUV444 format is converted into the specific multimedia data with the RGB format through a color space converter (CSC).

or,

if a format of the specific multimedia data is a YUV format, the first specific data is interpolated to obtain the specific multimedia data with the YUV444 format or the specific multimedia data with the YUV422 format.

It should be understood that the receiving device 15 provided is only taken as an example according to at least one implementation of the disclosure, and the receiving device 15 may have more or fewer components than illustrated, combine two or more components, or may adopt different arrangements of components.

Understandably, the specific implementation manner of the functional components included in the receiving device 15 of FIG. 15, reference may be made to the implementations of FIG. 7, and details are not described herein again.

A computer-readable storage medium is provided according to at least one implementation of the disclosure. The computer-readable storage medium stores a computer program, which is executed by a processor.

The computer-readable storage medium may be an internal storage unit of the device described in any of the foregoing implementations, such as a hard disk or a memory of the device. The computer-readable storage medium may also be an external storage device of the equipment or the like. Further, the computer-readable storage medium may also include both an internal storage unit of the device and an external storage device. The computer-readable storage medium is configured to store computer programs and other programs and data required by the equipment. The computer-readable storage medium can also be configured to temporarily store data that has been or will be output.

Those ordinary skilled in the art may realize that the modules and algorithm steps of each example described in combination with the implementations of the disclosure can be performed by electronic hardware, computer software, or a combination thereof. In order to clearly explain the interchangeability of hardware and software, the composition and steps of each example have been described generally in terms of functions in the above description. Whether these functions are performed in hardware or software depends on the specific application and design constraints of the technical solution. Professional technicians can use different methods to implement the described functions for each specific application, but such implementation should not be considered to be beyond the scope of the disclosure.

Those skilled in the art can clearly understand that, for the convenience and brevity of the description, the specific working processes of the devices and modules described above can refer to the corresponding processes in the foregoing implementations of method, and are not repeated here.

In the several implementations provided in the disclosure, it should be understood that the disclosed equipment, device, and method may be implemented in other ways. For example, to describe the composition and steps of each example. Whether these functions are executed in hardware or software depends on the specific application of the technical solution and design constraints. Professional technicians can use different methods to implement the described functions for each specific application, but such implementation should not be considered beyond the scope of this disclosure.

The implementations of device and equipment described above are only schematic. For example, the division of the modules is only a logical function division. In actual implementation, there may be another division manner. For example, multiple modules or components may be combined or integrated into another device, or some features can be ignored or not be implemented. In addition, the displayed or discussed mutual coupling or direct coupling or communication connection may be indirect coupling or communication connection through some interfaces, equipment, devices or modules, and may also be electrical, mechanical or other forms of connection.

The modules described as separate components may or may not be physically separated, and the components displayed as modules may or may not be physical modules, may be located in one place, or may be distributed on multiple network modules. Some or all of the modules may be selected according to actual needs to achieve the objects of the solutions in the implementations of the disclosure.

In addition, each functional module in each implementation of the disclosure may be integrated into one processing module, or each module may exist separately physically, or two or more modules may be integrated into one module. The above integrated modules may be implemented in the form of hardware or software functional modules.

When the integrated module is implemented in the form of a software functional module and sold or used as an independent product, it can be stored in a computer-readable storage medium. Based on this understanding, the technical solution of the disclosure essentially or a part that contributes to the existing technology, or all or part of the technical solution may be embodied in the form of a software product. The computer software product is stored in a storage medium which includes instructions to enable a computer device (which may be a personal computer, a server, or a network device, etc.) to perform all or part of the steps of the method described in the implementations of the disclosure. The foregoing storage media include: U-disks, mobile hard disks, read-only memory (ROM), random access memory (RANI), magnetic disks, or optical disks and other media that can store program codes.

The above is only a specific implementation of the disclosure, but the scope of protection of the disclosure is not limited to this. Any person skilled in the art can easily think of various equivalent modifications or replacements within the technical scope disclosed in the disclosure which should be covered by the protection scope of the disclosure. Therefore, the protection scope of the disclosure shall be subject to the protection scope of the claims.

What is claimed is:

1. A data transmitting method, comprising:
obtaining multimedia data;
processing the multimedia data to obtain a first data with a YUV420 format;
encapsulating the first data through a user datagram protocol (UDP) to obtain a UDP data packet; and
transmitting the UDP data packet to a first communication module via an input interface of the first communication module.

2. The method according to claim 1, wherein the multimedia data comprises:
obtaining the multimedia data via a high definition multimedia interface (HDMI); or
obtaining the multimedia data via a serial digital interface (SDI); or,
obtaining the multimedia data via a Type-C interface.

3. The method according to claim 1, wherein transmitting the UDP data packet to the first communication module via the input interface of the first communication module comprises:
transmitting the UDP data packet to a first optical module via an input interface of the first optical module, wherein the first optical module is configured to convert the UDP data packet into an optical signal, and the first optical module comprises an optical module with a transmission rate not lower than a first threshold; or,
transmitting the UDP data packet to a first electrical module via an input interface of the first electrical module, wherein the first electrical module comprises a communication module with the transmission rate not lower than the first threshold, and the communication module with the transmission rate not lower than the first threshold comprises a first physical transceiver and a first RJ-45 interface.

4. The method according to claim 1, wherein
when a format of the multimedia data is a RGB format, processing the multimedia data to obtain the first data with the YUV420 format, comprises:
converting the multimedia data with the RGB format into the multimedia data with the YUV444 format through a color space converter (CSC), and sampling the multimedia data with the YUV444 format to obtain the first data with the YUV420 format; or,
when the format of the multimedia data is a YUV format, processing the multimedia data to obtain the first data with the YUV420 format, comprises:
sampling the multimedia data with the YUV format to obtain the first data with the YUV420 format.

5. The method according to claim 1, wherein
the first communication module is configured to couple with a switch; or,
the first communication module is configured to couple with a receiving device.

6. The method according to claim 3, wherein
when the first communication module is the first optical module,
after transmitting the UDP data packet to the first communication module via the input interface of the first communication module, the method further comprises:
after converting the UDP data packet into optical signal by the first optical module, transmitting the optical signal, via an optical interface of the first optical module, to a switch; or,
after converting the UDP data packet into the optical signal by the first optical module, transmitting the optical signal to a receiving device via the optical interface of the first optical module.

7. The method according to claim 3, wherein
when the first communication module is the first electrical module,
after transmitting the UDP data packet to the first communication module via the input interface of the first communication module, the method further comprises:
transmitting the UDP data packet to a switch via an electrical interface of the physical interface transceiver in the first electrical module such as a RJ-45 interface and a cable; or,
transmitting the UDP data packet to a receiving device via the electrical interface of the physical interface transceiver in the first electrical module such as the RJ-45 interface and the cable.

8. The method according to claim 1, wherein
the first communication module comprises a first optical module and a first electrical module, and
transmitting the UDP data packet to the first communication module via the input interface of the first communication module comprises:
transmitting the UDP data packet to the first optical module via an input interface of the first optical module, and
transmitting the UDP data packet to the first electrical module via an input interface of the physical interface transceiver in the first electrical module simultaneously.

9. A data receiving method, comprising:
obtaining a user datagram protocol (UDP) data packet from a second communication module via an output interface of a second communication module;
decapsulating the UDP data packet through a UDP to obtain a first specific data with the YUV420 format; and
recovering the first specific data to obtain specific multimedia data.

10. The method according to claim 9, wherein obtaining the UDP data packet from the second communication module via the output interface of the second communication module comprises:
obtaining the UDP data packet from the second optical module via the output interface of the second optical module, wherein the second optical module is configured to convert the optical signal obtained from a transmitting device or a switch into a UDP data packet, and the second optical module comprises an optical module with a transmission rate not lower than a second threshold; or,
obtaining the UDP data packet from the second electrical module via an output interface of the second electrical module, wherein the second electrical module is configured to obtain the UDP data packet from the transmitting device or the switch, the second electrical module comprises a communication module with the transmission rate not lower than a second threshold, and the communication module with the transmission rate not lower than the second threshold comprises a second physical transceiver and a second RJ-45 interface.

11. The method according to claim 9, wherein
when a format of the specific multimedia data is a RGB format, recovering the first specific data to obtain specific multimedia data comprises: interpolating the first specific data to obtain data with a YUV444 format, and converting the data with the YUV444 format into the specific multimedia data with the RGB format through a color space converter (CSC); or,
when the format of specific multimedia data is a YUV format, recovering the first specific data to obtain specific multimedia data comprises: interpolating the first specific data to obtain the specific multimedia data with the YUV444 format or the specific multimedia data with the YUV422 format.

12. The method according to claim 9, wherein
the second communication module is configured to couple with a switch; or,
the second communication module is configured to couple with a transmitting device.

13. The method according to claim 9, wherein
when the second communication module is the second optical module,
before obtaining the UDP data packet from the second communication module via an output interface of the second communication module, the method further comprises:
obtaining an optical signal from a transmitting device via the input interface of the second optical module, and converting the optical signal into a UDP data packet by the second optical module; or,
obtaining the optical signal from a switch via the input interface of the second optical module, and converting the optical signal into a UDP data packet by the second optical module.

14. The method according to claim 9, wherein
when the second communication module is the second electrical module, before obtaining the UDP data packet from the second communication module via the output interface of the second communication module, the method further comprises:
obtaining the UDP data packet from a transmitting device via an input interface of the physical interface transceiver in the second electrical module; or,
obtaining the UDP data packet from a switch via the input interface of the physical interface transceiver in the second electrical module.

15. The method according to claim 9, wherein
before obtaining the UDP data packet from the second communication module via the output interface of the second communication module, the method further comprises:
obtaining the UDP data packet from a switch via the input interface of the second optical module, and simultaneously obtaining the UDP data packet from the switch via the input interface of the physical interface transceiver in the second electrical module; or,
obtaining the UDP data packet from the transmitting device via the input interface of the second optical module, and simultaneously obtaining the UDP data packet from the transmitting device via the input interface of the physical interface transceiver in the second electrical module.

16. The method according to claim 9, wherein
after recovering the first specific data to obtain specific multimedia data, the method further comprises:
outputting the specific multimedia data to a display device via an output interface such as a high definition multimedia interface (HDMI), a serial digital interface (SDI), or a Type-C interface, wherein the display device is configured to display or play the specific multimedia data.

17. A transmitting device, comprising:
a first memory configured to store a first application program instruction; and
a first processor coupled to the first memory and configured to invoke the first application program instruction to:
obtain multimedia data;
process the multimedia data to obtain a first data with a YUV420 format;
encapsulate the first data through a user datagram protocol (UDP) to obtain a UDP data packet; and
transmit the UDP data packet to a first communication module via an input interface of the first communication module.

18. The transmission device according to claim 17, wherein the first processor configured to transmit the UDP data packet to the first communication module via the input interface of the first communication module is configured to:
transmit the UDP data packet to a first optical module via an input interface of the first optical module, wherein the first optical module is configured to convert the UDP data packet into an optical signal, and the first optical module comprises an optical module whose transmission rate is not lower than a first threshold; or,
transmit the UDP data packet to a first electrical module via an input interface of the first electrical module, wherein the first electrical module comprises a communication module with a transmission rate not lower than the first threshold, and the communication module with the transmission rate not low than the first threshold comprises a first physical transceiver and a first RJ-45 interface.

19. A receiving device, comprising:
a second memory configured to store a second application program instruction; and
a second processor coupled to the second memory and configured to invoke the second application program instruction to:
obtain a user datagram protocol (UDP) data packet from a second communication module via an output interface of a second communication module;
decapsulate the UDP data packet through a UDP to obtain a first specific data with the YUV420 format; and
recover the first specific data to obtain specific multimedia data.

20. The receiving device according to claim 19, wherein the second processor configured to obtain the UDP data packet from the second communication module via the output interface of the second communication module is configured to:
obtain the UDP data packet from a second optical module via an output interface of the second optical module, wherein the second optical module is configured to convert an optical signal obtained from a transmitting device or a switch into the UDP data packet, and the second optical module comprises an optical module whose transmission rate is not lower than a second threshold; or,
obtain the UDP data packet from a second electrical module via an output interface of the second electrical module, wherein the second electrical module is configured to obtain the UDP data packet from the transmitting device or the switch, the second electrical module comprises a communication module with a transmission rate not lower than a second threshold, and the communication module with the transmission rate not lower than the second threshold comprises a second physical transceiver and a second RJ-45 interface.
